(19) United States
(12) Patent Application Publication
(10) Pub. No.: US 2025/0218262 A1
(43) Pub. Date: Jul. 3, 2025

(54) Determining Actions of a System Based on Approaching Entity

(71) Applicant: Vivint, Inc., Provo, UT (US)

(72) Inventors: Erik Stephen Pfeiffer, Provo, UT (US); Michelle Bea Zundel, Provo, UT (US)

(73) Assignee: Vivint, Inc., Provo, UT (US)

(21) Appl. No.: 18/937,398

(22) Filed: Nov. 5, 2024

Related U.S. Application Data
(60) Provisional application No. 63/596,383, filed on Nov. 6, 2023.

(51) Int. Cl. G08B 13/196; G06V 20/52; H04L 67/306; H04L 67/52

(52) U.S. Cl. CPC G08B 13/19613; G06V 20/52; H04L 67/306; H04L 67/52

(57) ABSTRACT

Presented herein are system and methods for determining actions of a system based on an approaching entity. A system can include an image capture device, output devices, and one or more processors coupled with memory. The system can detect an entity within an area. The system can determine that the entity corresponds to one or more criteria. The system can identify one or more actions corresponding to the one or more criteria and a state of the area. The system can actuate one or more of the output devices to perform the one or more actions based on the entity.

### CROSS REFERENCE

This application claims priority to U.S. Provisional Patent Application, 63/596,383, filed Nov. 6, 2023, and entitled DETERMINING ACTIONS OF A SYSTEM BASED ON APPROACHING ENTITY, which is incorporated by reference herein in its entirety.

### TECHNICAL FIELD

This application relates generally to determining actions of a system based on an approaching entity. In particular, the present application relates to identifying and actuating an action based on criteria of an entity within an area to welcome or deter to the entity from the area.

### BACKGROUND

Entities enter into areas within a field of view of a camera, such as a property of a home protected by a security system. The entities can be unknown and unidentifiable, thereby making it difficult to distinguish between friendly entities and unfriendly entities. Furthermore, an unfriendly entity may perpetrate an event, such as a burglary, solicitation, vandalization, or other undesirable event, while a friendly entity may be returning home, coming for a visit, bringing a gift, or other desirable events. The security system may respond to friendly or unfriendly entities in the same manner, due to not identifying the entities. For example, the security system may alarm friendly entities or unfriendly entities. In this manner, the system may become dysfunctional and waste resources such as power and bandwidth.

### SUMMARY

The present disclosure is directed to systems and methods for determining actions based on an approaching entity. Upon detecting the presence of an entity, a system may perform an action to welcome or to deter an entity. The camera may identify an action based on the entity within the area. For example, the camera may emit a siren or other such noise upon a detection of an entity in the area to alert homeowners or neighbors of the entity and to further deter the entity from perpetrating the event. Conversely, the camera may turn on lights, unlock a door, or otherwise initiate actions inside or outside of the home to receive a friendly entity. The system may not identify the entity and thereby may not select an action which comports with the entity. For example, the action to welcome the entity may be performed regardless of the entity, such as welcoming an unfriendly entity like a burglar or solicitor. Similarly, the action to deter the entity may be performed regardless of the entity, such as deterring a friendly entity such as a homeowner or neighbor. The system may not monitor for a response received from the entity and thereby may not configure the action for the entity or acts performed by the entity, thereby negating the functionality of the system. For example, the system can produce false positive alarms due to not identifying the entity, which detract from efficiency of the system by wasting resources such as power used to produce an output or computational power. Furthermore, the system may fail to provide an action configured for the specific entity or acts which either welcomes a friendly entity or causes an unfriendly entity to refrain from perpetrating the event, further negating the functionality of the system and wasting resources.

To address these and other technical challenges, a system can be configured to identify and actuate an action based at least on the entity (e.g., considering characteristics of the entity). The system can detect the presence of the entity within a zone configured for the system. The entity can be a friendly entity, such as a known neighbor, the mailman, or a child, or an unfriendly entity, such as a suspected burglar, loiterer, or other suspicious entity. By using a variety of sensors as well as image recognition and audio recognition techniques, the system can determine a type of the entity. The system can determine to provide a welcoming action, such as lighting a path, or a deterring action, such as flashing lights, based on the type of the entity.

The system can identify a friendly entity and select a welcoming action based on the friendly entity. The system can identify, through facial recognition, voice recognition, gait analysis, or other such techniques, whether an entity is friendly or unfriendly. In some cases, the system can identify the entity as a recognized entity, such as an entity corresponding to a profile stored in a database of the system. The profile may identify the entity as a friendly or unfriendly entity. In some cases, the system can determine, based on characteristics of the entity, whether the entity is friendly or unfriendly. The system can determine other criteria of the entity. For example, there may be other subcategories of entity identification besides friendly or unfriendly. The system may define subcategories for the entities, such as friendly, unfriendly, neighbor, homeowner, salesman, mailman, among others and may identify an entity as a subcategory based on determined criteria of the entity.

The system can provide any one or more of a multitude of actions based on the identification of the entity. The system may select and actuate one or more actions based on the entity. Selecting or actuating the one or more actions can include stopping a performance of a previously selected or ongoing action. The system may select and actuate the actions based on the profile associated with the entity indicating preferences for actions. For example, the entity may select actions which correspond to preferences selected by the entity or determined for the entity by the system. The actions can include actuating any integrated subsystems, such as subsystems within a building like a climate control system, appliances within a building, electronic locks, speaker systems, lighting systems, among others. In some cases, the system selects the one or more actions based on the determined criteria of the entity, such as selecting an action based on a subcategory of the entity. For example, for a friendly entity, the system may select actions including playing a welcoming sound or unlocking a door for the friendly entity. In some cases, the system may select one or more actions based on an identification of an unfriendly entity to deter the unfriendly entity, such as flashing lights, changing a color of lights, playing deterrent sounds, turning on a sprinkler system, among others.

In this manner, the system can provide for an action using one or more subsystems of a building to welcome or deter entities based on an identification of the entity within a zone of the building. The system can further actuate subsystems of the building outside of the zone based on the identification of the entity. The detection of the entity includes images, sensed measurements, or audio associated with the entity or the environment in which the entity is within. The system can determine a type of the entity from the detection and can determine one or more actions to provide via one or more subsystems of the system. The actions can be configured for the entity and updated based on a continuous monitoring of the entity's response to the actions. The ability to generate a customized environment to welcome or deter an entity reduces the waste of computational resources by reducing false-positive alarms as well as by providing a targeted response most in line with the intentions of the entity.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates a block diagram of an example system for determining actions of a system based on an approaching entity.

FIG. 2 illustrates a flow diagram of an example system for determining actions of a system based on an approaching entity.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for generating overlayed sounds to deter perpetration of an event. A camera system can detect an entity, such as a person, within an area. The camera system can determine that the entity corresponds to one or more criteria. Based on the one or more criteria, the camera system can identify a first sound to play to the entity. The camera system can identify a second sound based on the one or more criteria and play the second sound with the first sound to deter the entity from perpetrating an event.

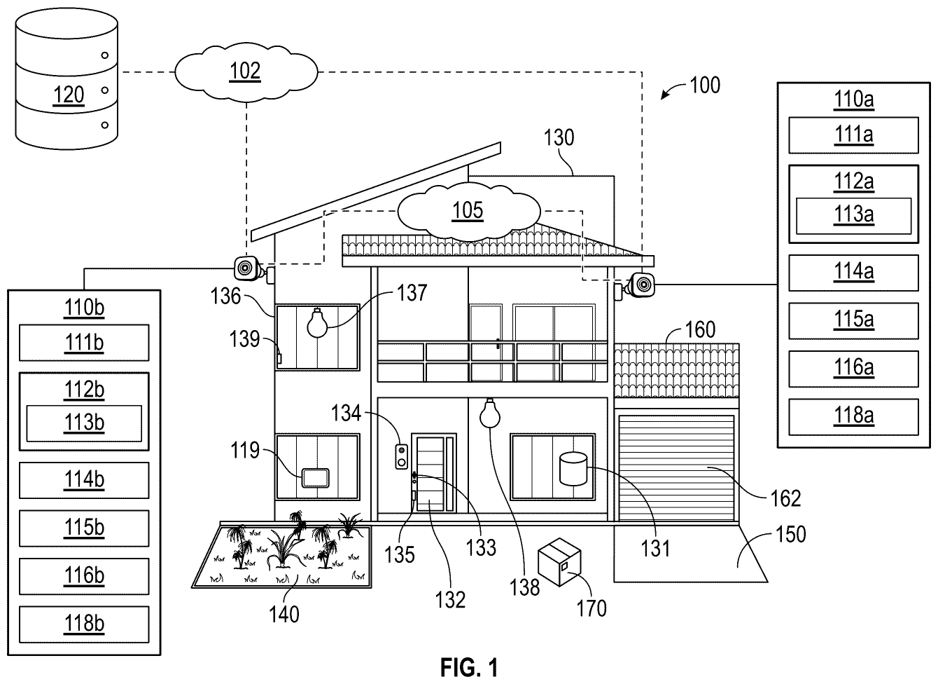

FIG. 1 illustrates an example environment 100 in which the present systems and methods may be implemented. The environment 100 may include a site that can include one or more structures, any of which can be a building 130 such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property or building. In an example, the environment includes a cul-de-sac including multiple homes.

The environment 100 may include a first camera 110a and a second camera 110b, referred to herein collectively as cameras 110. The cameras 110 may be attached to the building 130. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b may be trained together using data from the cameras 110. In some implementations, the AI model 113a and the AI model 113b may be initially the same, but may be independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, one or more of the AI models 113 may be trained using data collected from one or more cameras associated with a one or more buildings. The cameras 110 may share data with the server 120 for training the one or more AI models 113 and/or one or more other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100). In some embodiments, the identification of the object 170 as being within the area may be based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114. As used herein, “depth data” may refer to distance from the camera, and/or depth-of-field, giving “depth” to the image data when the radar or depth data are correlated with the image data.

In some embodiments, the area may be defined as a complete field of view of the corresponding camera 110. In other embodiments, the area may be pre-defined as a subsection of the field of view of the corresponding camera 110. The pre-definition of the area may be set as a default. In some embodiments, the area may be selected and/or set. For example, a user may define the area within the field of view of the camera. The user may define the area by dragging boundaries or points within a visual representation of the field of view of the cameras 110, or other sensors. In another embodiment, the user may select areas by clicking, tapping, or otherwise selecting the area generally resulting in an intelligent analysis and selection of the area. In some embodiments, the user may select from one or more pre-determined areas suggested to the user. The user may select and apply or modify a pre-determined area.

In other embodiments, the area may be determined without input from a user. For example, the AI model 113 may analyze the field of view of one or more of the cameras 110 and identify one or more portions of the field of view to designate as one or more areas to monitor. In some embodiments, the AI model 113 may identify the area based on data gathered over time, by an analysis of the field of view of the one or more cameras 110 and/or based on training data corresponding to environments having correlated aspects or characteristics for setting the area.

In some embodiments, the cameras 110 may provide overlapping fields of view. In some example, one or more areas may be defined within an overlapping portion of the fields of view of the cameras 110. One or more other areas may be defined which correspond to a field of view of one of the cameras 110 and not a field of view of another of the cameras 110. In some embodiments, the cameras 110 may generate a composite view of an area corresponding to two or more of the cameras 110. The area may be defined using a field of view of one of the cameras 110 and transposed to at least one other of the cameras 110 containing at least a portion of the defined area.

The environment 100 may include a user interface 119. The user interface 119 may be part of a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116. One or more sounds may be selected from one or more stored sounds (e.g., stored on memory 112, the server 120, or at another resource or asset. In some embodiments, the user may speak and have the spoken sound communicated directly to one or more speakers 116 associated with one or more of the cameras 110 or separate from the one or more cameras 110.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and/or a weighting protocol and/or other methodology to determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). For example, an objection 170 may be confirmed if more sensors agree than disagree or if two or more sensors agree. In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the cameras 110 may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 101. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the cameras 110 may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the cameras 110 are configured to play and/or otherwise emit one or more sounds in response to detecting the presence of a human within an area. For example, the cameras 110 may play one or more sounds selected to deter a detected person from an area around a property/building 101 and/or object. The cameras 110, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The camera 110, in some implementations, stores and/or has access to a library comprising a plurality of different sounds and/or a set of dynamically generated sounds so that the controller 106 may vary the different sounds over time, not using the same sound often. In some embodiments, varying and/or layering sounds allows a deter sound to be more realistic and/or less predictable.

One or more of the sounds may be selected to give a perception of human presence in the building 101, a perception of a human talking over an electronic speaker device, or the like which may be effective at preventing crime and/or property damage. For example, a library and/or other set of sounds may include audio recordings and/or dynamically generated sounds of one or more, male and/or female voices saying different phrases, such as for example, a female saying “hello?”, a female and male together saying “can we help you?”, a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like.

In some implementations, the cameras 110 may dynamically generate one or more sounds (e.g., using machine learning and/or other artificial intelligence, or the like) with one or more attributes that vary from a previously played sound. For example, the cameras 110 may generate sounds with different verbal tones, verbal emotions, verbal emphases, verbal pitches, verbal cadences, verbal accents, or the like so that the sounds are said in different ways, even if they include some or all of the same words. In some embodiments, the cameras 110 and/or a remote computer 125 may train machine learning on reactions of previously detected humans in other areas to different sounds and/or sound combinations (e.g., improving sound selection and/or generation over time).

The cameras 110 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The cameras 110, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the cameras 110 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the cameras 110 may play a primary sound layered and/or overlapping with one or more secondary, tertiary, and/or background sounds, varying the sounds and/or the combination from one or more previously played sounds and/or combinations, or the like.

The cameras 110, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The cameras 110, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the cameras 110 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the cameras 110 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120, may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data. For example, the AI models 113 may be trained using training data that may include one or more images of the object to be identified, validation data to validate the operation of the AI models 113, key performance indicators (KPI) or other test/evaluation data to assess the capability of the AI models 113 to identify an object in the field of view of one or more of the cameras 110.

In some implementations, the cameras 110 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

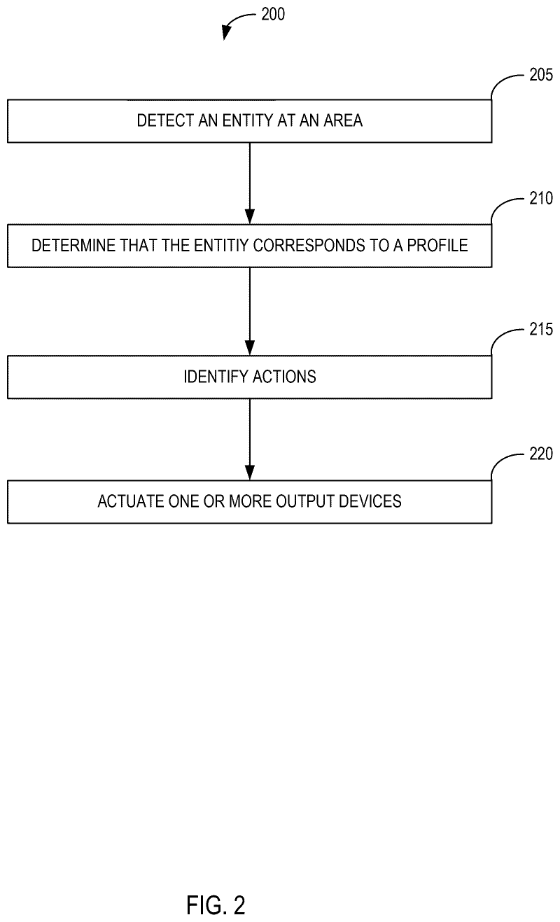

FIG. 2 depicts a flow diagram of a method 200 for determining actions of a system based on an approaching entity. The method 200 may be implemented or performed using any of the components detailed herein. Embodiments may include additional, fewer, or different operations from those described in the method 200. The operations may be performed in the order shown, concurrently, or in a different order. The method 200 may be performed by one or more components of the environment 100. For example, the method 200 may be performed by the first camera 110a, the second camera 110b, or the cameras 110.

The system can detect an entity at (e.g., within, approaching) an area (205). The system can include one or more image capture devices, such as the cameras 110, or another image sensor. The system can include one or more additional sensors, such as the various sensors of the environment 100 (e.g., the window sensor 139, the door sensor 135, radar sensor(s) 114, microphone(s) 118, among others). Through the methods described herein with reference to FIG. 1, the system can detect an entity using at least one of the cameras 110 and/or the various sensors (e.g., radar sensor(s) 114, microphone(s) 118, Bluetooth connectivity detector, WiFi connectivity detector). In some cases, the system can capture images of the entity using one or more of the cameras 110, the doorbell camera 134, or another camera of the system. The images can be any form of image, such as a video, still image, single or multiple frames of images, among others. In some cases, the images can include images in the visible light spectrum such as color or black and white images. In some cases, the images can include images in the invisible light spectrum, such as infrared or ultraviolet images.

The entity can be a person within the environment 100. In some cases, the entity can include multiple persons within the environment 100. The entity can be known or unknown to a homeowner, resident, responsible person, or neighbor of the building 130. For example, the entity can include the mailman, a stranger, a child, a friend, a gardener, or a group of these people or other people. The entity can include a homeowner, resident, or neighbor of the building 130. In some cases, the entity can be a friendly entity, such as the homeowner, a visitor, the mailman, a relative, among others. A friendly entity can be or include an entity which is welcome, invited, or to be received to the building 130, has business in or around the building 130, or otherwise has positive intentions for the building 130 or its occupants. In some cases, the entity can be an unfriendly entity. An unfriendly entity can be or include an entity who is not welcome to the building 130 or the surrounding areas, an entity who is to be deterred from the environment 100, or an otherwise undesirable entity. The system can detect the entity within an area of the environment, such as in the first region of interest 140 or the second region of interest 150, among others.

The system may detect the entity within the area by detecting one or more physical characteristics of the entity or behavioral characteristics of the entity. In some cases, the system may determine from the images, or other measurements from the sensors of the environment 100, characteristics of the entity which correspond to a person. The physical or behavioral characteristics may include the person carrying an object, such as a knife, crowbar, gift, package, or other such objects. The characteristics may include the detected person making noises such as shouting, whispering, stomping, or speaking. The characteristics may include the detected person engaging with a part of the building 130, such as the door 132, the e-lock 133, the exterior light 138, a window, an outlet, or the like. Physical characteristics which may correspond to an entity include a temperature of a region within the area, a shape of the entity, a size of the entity, a sound of the entity (e.g., a vocal pitch or tone), among others. Behavioral characteristics of the entity may include movements of the entity (e.g., a gait or gesticulation), a sound of the entity (e.g., a cadence of speech or a selection of words spoken), or other such behavioral characteristics described herein.

The system may determine that the entity corresponds to one or more profiles (210). The system may process the measurements from the various sensors of the environment 100 including the images captured by the cameras 110 to determine one or more criteria of the entity. The criteria of the entity may include a type of the entity, an identity of the entity, a perceived intention of the entity, among others. For example, a type of the entity may include a profession, an intention (e.g., friendly or unfriendly), a social classification (e.g., neighbor, friend, mother, criminal), demographic information of the entity (e.g., a sex, gender, age, ethnicity, or race), among others. An intention of the entity may include an event which the entity is determined likely to perpetrate, such as trimming a garden of the environment 100, stealing an object from a region of interest of the environment 100, visiting an occupant of the building 130, or coming home to the building 130, among others.

An identity of the entity may include a name, an identifier of a device associated with the entity (e.g., a MAC address or TMSI of a phone of the entity, among others), a vehicle associated with the entity, among others. In some embodiments, speech or other sound detected from the entity may identify the entity, such as through vocal pattern recognition techniques that associate a voice with an entity or by the entity self-identifying through speech (e.g., “It's me, Jane Doe”).

The criteria may be determined from one or more measurements detected by one or more sensors detecting the environment 100. The one or more sensors of the environment 100 (e.g., the door sensor 135 or other entrance sensor, the doorbell camera 134, the window sensor 139, the radar sensor 114, the image sensor 115, or the microphone 118) may detect measurements associated with criteria corresponding to a state of the environment. For example, a first measurement within a range of temperatures, a second measurement within a range of heights, and a third measurement within a range of cadence can correspond to a criterion associated with a type of entity. For example, a detection by the sensors of a person moving below a threshold speed and speaking in whispers can indicate a criterion associated with a burglar.

In some embodiments, image processing may be utilized to detect or otherwise identify an entity at (e.g., within, approaching, affecting, etc.) an area as corresponding to the one or more criteria. In some embodiments, a machine-learning model may be trained and utilized to detect or otherwise identify the entity at the area as corresponding to the criteria, or the machine learning model may be trained and utilized to determine the criteria to which the entity within the area corresponds. The machine-learning model may be trained by applying the machine-learning model on historical data including image data of various objects and entities. In an example, a burglar may be identified, using a machine-learning model executed on a camera, on a porch of a house. In an example, a homeowner may be identified, using a machine learning model executed on a camera, approaching a porch of the house via a walkway. Determining the criteria may include tracking movement of the entity into the area. In an example, a burglar (e.g., an unfriendly entity) may be identified, using a machine-learning model executed on a camera, by tracking the movement of the burglar across a lawn of the house to a window of the house. In an example, a neighbor (e.g., a friendly entity) may be identified, using a machine learning model executed on a camera, by tracking the movement of the neighbor down a walkway towards a porch of the house. The entity may be identified as an entity type, such as friendly or unfriendly, based on the movement of the entity within the area. For example, an entity may be identified as an unfriendly entity based on movements performed by the entity which correspond to (threshold comparison, matching, weighted calculation, etc.) criteria of a burglar, such as pacing in place, crouching, shaking a door, or checking over his shoulder. The entity may be identified as an unknown or unrecognized entity based on a comparison of a face, movements, a voice, or other biometrics of the entity to a repository of known entities, such as performed by a machine-learning model executing facial or other recognition techniques. The cameras 110 may perform image recognition functions as described herein to identify the criteria corresponding to the entity. For example, the cameras 110 may analyze the captured images for a gait of the entity, a face of the entity (e.g., by facial recognition), objects the entity may be carrying, among others as described herein. In some cases, the cameras 110 can identify features of the entity from the images. Features of the images can include an object carried by the entity, a facial profile or structure of the entity, biometrics of the entity, clothing worn by the entity, among others.

The system may determine that the entity is approaching the area based on a device associated with the entity. In some cases, the entity may own, carry, or otherwise be associated with a device such as a cellphone, tablet, laptop, or other such connected, detectable, and/or communication-capable device. The device may be in communication with the network 102. For example, the device may transmit, via the network 102, data via the network 102 to communicate with devices of the environment 100, such as the camera 110. The device may transmit an indication to components of the environment 100, such as the camera 110, that the entity is approaching the environment 100, the building 130, or another area of the environment 100. Upon receipt of the indication, the system may determine that the entity is approaching the area.

The device associated with the entity may transmit the indication responsive to the device determining that it is within a geographic area. For example, upon entering or leaving a geofence associated with the entity, the device may generate and transit the indication. As an illustrative example, the device may determine, based on a GPS location, cell tower triangulation, WiFi network connection, or other means of determining location, that the entity is within a perimeter of the building 130. Upon entering the perimeter of the building 130, the device associated with the entity may generate and transmit the indication that the entity has entered the perimeter of the building 130 or other geographic area. The device may determine that the entity has exited a perimeter and may generate and transmit the indication as a result of the determination. For example, the device may detect that the entity has exited a perimeter associated with a location the entity has visited, such as a job, gym, doctor's office, friend's house, among others. Upon leaving the perimeter associated with the visitation location, the device associated with the user may generate and transmit the indication that the entity is approaching the environment 100.

The device associated with the entity may transmit the indication responsive to a schedule of the entity. In some cases, the system may determine, using one or more machine learning models, a schedule associated with location of the entity, such as a work schedule, volunteer schedule, or other schedule of being outside a perimeter of the environment 100. Based on the schedule, the device may determine the transmit the indication upon a time of the schedule indicating that the entity is approaching the environment 100. The device may transmit the indication responsive to tasks performed by the entity on the device. For example, the entity may track a weightlifting session on the device via an application associated with exercise. Upon the entity marking completion of the weightlifting session on the application, the device may generate and transmit the indication that the entity is approaching the environment 100.

In some cases, the indication can include an identification of a profile associated with the entity. As described herein, the entity can be associated with a profile. The indication can include an identifier of the profile associated with the entity. In this manner, the system can identify the entity based on the profile indicated in the indication.

The system may determine from at least one of the criteria determined based on the measurements and/or images by the machine-learning model, that the entity corresponds to a type of person, such as an unfriendly person, a friendly person, a mailman, etc. In some cases, the system may determine, by providing images to the machine learning model, that the entity corresponds to one or more types. For example, the system may determine that an entity is both friendly and a neighbor, or the system may determine that an entity is both unfriendly and a neighbor. In some cases, the system may determine that features of the entity determined from image recognition techniques performed by the cameras executing a machine-learning model meet a threshold for features of the one or more criteria. As an illustrative example, a criteria corresponding to a burglar may be associated with features related to a gait of an entity being slow, crouched, or crawling, features related to clothing of an entity being black and fully covering, a face of an entity being obscured, among others. Continuing with the example, the system may determine, based on the machine learning model, that the features meet a threshold number of features to identify the entity as corresponding to a criteria. As an illustrative example, a criteria corresponding to a friendly entity may be associated with features related to a gait of an entity being upright, at a particular stride, and at a particular speed.

A type and/or identity of the entity may be determined. In an example, a camera, using a machine-learning model, may identify an entity as a type as described herein based on one or more features of the entity matching a type criteria. In an example, the machine-learning model may classify the entity as the mailman. In an example, a camera, using a machine-learning model, may determine an identifier of an entity, such as a nametag or an identifier of a device associated with the entity, such as a MAC address or TMSI of a cellphone. The camera may associate the identifier with an image of the entity and send a notification to a person associated with the area in which the entity is. In this way, the camera can monitor, and report to the person, an entity within the area who may be perpetrating an event such as a crime, a delivery of a package, or a visit to the home, among others. In an example, the camera may generate a notification to the user that an unknown entity or an entity matching the criteria of a type or identified to correspond to the criteria of a type is in the area. The notification may identify the entity, such as by transmitting an image of the entity to the person via a device associated with the person.

In some embodiments, the system may detect the entity as a friendly entity based on a device associated with the friendly entity. The friendly entity may, through the user interface 119 operating on the device, transmit a notification to the system indicating an arrival of an entity. In some cases, the notification may self-identify. For example, the device may transmit a notification that the entity is within a certain range, geofence, or approximate time from entering the environment 100, the building 130, or an area of interest of the environment 100. In some cases, the entity can select to transmit the notification via the user interface 119 or the device associated with the entity may automatically transmit the notification to the system upon detecting a threshold distance or time from the environment 100 or the building 130, among others.

In some embodiments, the system may, using a machine learning model trained based on images from the camera 110 or the sensors of the environment 100, learn or generate a schedule for a friendly or unfriendly entity. For example, the system may determine, from image processing techniques described herein, that an entity determined to be unfriendly arrives within a threshold time every day, week, or other frequency, such as a solicitor or collections agent. For example, the system may determine that an entity determined to be friendly arrives to the building 130 within a threshold time every day, week, or other frequency, such as the entity returning home from work.

In some embodiments, the method 200 can include determining that the entity corresponds to a profile (210). The profile may identify the entity by the identification methods described herein. The profile can include the determined one or more criteria for the entity. For example, the profile can include images of the entity, a voice of the entity, a type of the entity, an identification of the entity, or other such information gathered about the entity from at least the cameras and/or the sensors. The profile can include a schedule of the entity, as determined from the machine learning model described herein. In some cases, one or more profiles can be updated, added, modified, or deleted from at least the user interface 119. For example, a homeowner may add profiles of family members to the system via the user interface 119. The homeowner may assign criteria associated with the input entities, such as defining a profile corresponding to a family member as friendly, a profile corresponding to a nosy neighbor as unfriendly, or a profile corresponding to the mailman as friendly. The homeowner may define criteria for each entity corresponding to a profile or may remove criteria associated with a profile. For example, a profile may include a teenage boy as a friendly entity, but the homeowner may select to remove the profile of the teenage boy, or change the profile from indicating the teenage boy is friendly to indicating that the teenage boy is unfriendly.

Image processing may be utilized to detect or otherwise identify the entity within a field of view of a camera 110 or image data captured therefrom. In some embodiments, a machine-learning model may be trained and utilized to detect or otherwise identify the entity. The machine-learning model may be trained by applying the machine-learning model on historical data including image data of various persons in various clothing. In some implementations, determining that the entity corresponds to a profile may include identifying the entity. Determining that the entity corresponds to the profile may include detecting a presence of a person. Determining that the entity corresponds to a profile may include determining one or more characteristics of the entity, such as the behavioral or physical characteristics described herein. For example, determining the one or more characteristics of the entity may include determining clothing, height, girth, weight, hair color, gait, category, profession, identity, and/or other characteristics. In an example, a camera executing a machine-learning model may determine that an entity is wearing black pants and a black shirt. In an example, a camera executing a machine-learning model may determine that an entity is a mail carrier or a delivery driver. In an example, a camera executing a machine-learning model may determine that an entity is a male teenager. In an example, a camera executing a machine-learning model may determine an entity's identity using facial recognition and/or other characteristics. Determining the one or more characteristics of the entity may include determining one or more actions of the entity. In an example, a camera executing a machine-learning model may determine that an entity is attempting to hide from the camera. In an example, a camera executing a machine-learning model may determine that a entity has passed by a house multiple times. In an example, a camera executing a machine-learning model may determine that an entity is looking in the windows of a house.

In some cases, the system may determine that the entity corresponds to the profile responsive to determining that features, criteria, or characteristics of the entity meet a threshold. For example, using the machine learning models described herein, the system may determine that a facial feature of the entity matches a facial feature of the profile above a threshold accuracy, certainty, or other threshold as to determine that the entity corresponds to the profile. In some cases, the system may determine, based on a threshold number of features matching features indicated in the profile, that the entity corresponds to the profile. For example, the entity may satisfy a threshold for a number of features to determine that the entity corresponds to the profile.

The system may determine that no profile corresponds to the entity. The system can, based on at least the determined characteristics and criteria of the entity, generate a profile for the entity. Upon determining that no profile corresponds to the entity, the system may determine that the entity is an unfriendly entity. Responsive to determining that the entity is unfriendly, the system may generate a profile for the unfriendly entity indicating that the entity is unfriendly. In some cases, the system may not generate a profile for the unfriendly entity.

In some cases, the system can generate a profile for the entity upon determining that the characteristics, criteria, or features of the entity correspond to a friendly entity. In some cases, the profile can be generated based on user input. For example, a user associated with the system may input, generate, or create a new profile for an unknown entity. The user associated with the system can edit, modify, or delete one or more profiles associated with the system. For example, the user can modify one or more preferences of a profile. The preferences of the profile can correspond to a schedule of the user, actions of the system by the user, or a combination thereof. For example, the profile can indicate that a user enjoys coffee between 6 AM to 10 AM, but not otherwise. The system may determine the preferences associated with a profile for an entity using the machine learning model. In some cases, the system may determine, based on historic actions of the entity taken within the area, preferences of the entity. For example, the system may recognize, based on image recognition, object detection, or other such camera-based techniques described herein, that the entity drinks coffee between 6 AM-10 AM a threshold percentage of the time that the entity drinks coffee. Based on the detection of the entity drinking coffee at particular times, the system may generate a preference to store in the profile of the entity indicating that the entity drinks coffee between 6 AM-10 AM. As another illustrative example, the system may determine that the entity approaches the building 130 between 5:30-6:30 PM on Monday through Friday and may generate a preference for the entity related to opening the garage door at such a time. In this manner, the machine learning model can adjust the preferences of the profile based on historic actions of the entity.

In some cases, the machine learning model can be trained by user input. The machine learning model can be trained by user input prior to detecting an entity, responsive to detecting an entity, or a combination thereof. A user can train the machine learning model based on images captured of an entity. For example, the camera 110 may capture images of an entity and transmit those images to the user interface 119 executing on, for example, a control panel or user device. The user interface 119 may receive a selection indicating that the image represents one or more criteria of an entity. For example, the user interface 119 may present an image including an entity and may receive a selection of a criteria associated with the image, such as “friendly,” “unfriendly,” “neighbor,” etc. In some cases, the image presented by the user interface 119 may be an image of the environment 100 captured by the camera 110. For example, the camera 110 may capture an image of a neighbor, intruder, delivery driver, or other entity within the environment 100. The camera may transmit the image of the entity to the user interface 119 concurrently with the image capture, at a scheduled transmittal, or responsive to receiving a request to define criteria, among others. In some cases, the user interface 119 may present images of entities not captured by the camera. For example, the user interface 119 or the camera 110 may retrieve (via the network 102) images of entities, such as from the server 120, to present to the user to train the machine learning model. Upon receiving a selection of one or more criteria for an image of an entity, the machine learning model may utilize the image with the associated selected criteria as training input to identify entities and criteria of the entities from captured images. For example, the machine learning model may identify measurements, behavioral characteristics, or physical characteristics, among others, within the image and associate those identified measurements or characteristics with the selected criteria. In this manner, the machine learning model can be iteratively trained through user input defining criteria for images presented via the user interface 119.

In addition to capturing measurements and images to determine a profile corresponding to the entity for the detected entity within the area, the system can process the measurements and/or the images to determine a state of an area. The system can process the measurements prior to the arrival of the detected person or upon the arrival of the detected person to determine the state of the area. The system may employ one or more machine-learning models to determine the state of the area. For example, the machine learning-model may be trained on historical states of the area during different time periods, different persons in or around the area, and with different noises corresponding to the state. The state of the area can refer to a time period of the area, a setting of the area (as input through the user interface 119), among others, that determines a set of security actions available for selection by the camera 110. In some implementations, the state can include an occurrence of a holiday. For example, at Halloween or Christmas, it may be commonplace for unknown individuals (e.g., trick-or-treaters or carolers) to approach the building 130, and thereby the camera 110 may select from a set of security actions based on the holiday occurring. In some implementations, the state can include a time of day, such as a time of day programmed or recognized by the cameras 110 as when the environment 100 is unoccupied (e.g., all residents are at work or school). In some implementations, the state can include a party occurring, such that one or more unknown vehicle or persons may be within the environment 100. In some implementations, the state can include a vacation, in which the residents are not within the environment for a longer period of time than during their typical schedules. In some implementations, the state can include a region of interest occupied, such as children playing in the lawn or a band practicing in the garage 160.

In some implementations, the system can transmit information about the entity to a client device associated with the area. For example, the system can transmit the profile generated for the entity to a cellphone of an owner or resident of the building 130. The client device may transmit or upload information about the entity to the profile. For example, a user of the client device may input (via the user interface 119) a name of the entity into the profile based on an image of the entity transferred to the client device.

The system can identify actions (215). The system can identify one or more actions corresponding to the profile of the entity, such as to the preferences indicated in the profile. In some cases, the system can identify the actions to provide via output devices of the building, such as output devices associated with subsystems of the building. The actions can include instructions to actuate, cause, or otherwise initiate functionalities of subsystems of the building 130 or the environment 100. The system can identify the actions from one or more sources. For example, the system can identify an action by selecting the action from a library of actions based on a mapping between the profile of the entity, the state of the area, and the actions within the library of actions.

The actions can correspond to the preferences of the entity indicated in the profile. The actions can be preparatory or indicative of the entity approaching the environment 100 or areas of the environment 100, such as the building 130. In some cases, the actions can serve to welcome the entity, or otherwise make it appealing for the entity to remain or reside within the environment 100. In some cases, a first set of actions may correspond to a friendly entity and a second set of actions may correspond to an unfriendly entity. The first set of actions corresponding to a friendly entity can be to receive the entity. Receiving the entity can include any actions which are configured to welcome, invite, include, calm, provide case, provide joy, or otherwise positively impact the entity. For example, the first set of actions may include actions such as lighting a pathway leading to the building 130 (e.g., turning on a light system to guide the entity within the area), unlocking a door of the building 130, opening a door of the building 130, playing a welcoming noise (e.g., music, a greeting, sound effect, etc.) from the speakers 116, climate controlling the building 130, starting an appliance (e.g., a coffee maker or preheating an oven) of the building 130, among others. Stated otherwise, actions configured to receive the entity may be designed for an entity to remain at and/or further approach or enter into the environment 100. The second set of actions can be to deter the entity. For example, the second set of actions may include actions such as flashing lights, emitting a siren, whistle, or other warning noise, locking a door of the building 130, turning on a sprinkler system of the environment 100, among others. Actions that deter the entity may be configured to induce an entity to terminate a present course of action and/or to flee or otherwise move away from or leave the environment 100.

The system may provide the profile of the entity to a machine learning model to identify the one or more actions. In some cases, the preferences of the profile can indicate actions to take based on the state of the area, the criteria of the entity, or a combination thereof. For example, the system may provide images of the entity, from the camera 110, to determine the profile of the entity and to select actions to perform based on the criteria and the state of the area. The system may select one or more actions based on the criteria of the detected entity. For example, the system may select, using the machine learning model, one or more actions from the first set of actions if the system determines the entity to be friendly. The system may provide the criteria to the machine learning model to determine which, if any, of the actions to select based on the criteria. For example, the system may identify the actions to turn on a climate control system of the building 130 to cool the building based on an output from the machine learning model to cool the building. In this illustrative example, the machine learning model may take as inputs a temperature of the entity, a gait of the entity, a determined schedule of the entity, facial recognition of the entity, among others, to determine that a friendly entity has just gone for a jog and identify the action of cooling the building 130.

The system may select one or more actions based on the state of the area. For example, the state of the area may correspond to an illumination the environment 100. If the environment is bright (e.g., during daytime), the state of the area may correspond to daytime and the machine learning model may determine to not select an action corresponding to turning on a porch light. The area may correspond to a time period, by which the machine learning model can determine which actions, if any, to identify. For example, the system may determine that no friendly entities are scheduled to be approaching or within the area at a given time. The state of the area may indicate a period of time in which any entity is to be determined unfriendly. For example, the system may determine that any entity approaching within a threshold period of time (e.g., 11 P.M to 5 A.M.) is an unfriendly entity. For example, the state of the area may indicate a vacation state, in which any entities approaching the building 130 during a period of time (e.g., 1 week) are to be classified as unfriendly. The state of the area may indicate a holiday, during which entities which may have been otherwise classified as unfriendly may be classified as friendly. For example, a state of the building 130 corresponding to Halloween may prevent the system from determining an entity to be unfriendly based on facial recognition techniques, but may still determine an entity to be unfriendly based acts of the entity such as interacting with a window of the building 130.

The system can actuate one or more output devices (220). The system can generate instructions to transmit over the local network 105 and/or the network 102 to actuate one or more output devices of the environment 100. The output devices can include devices and/or subsystems of the environment 100 that provide a function, produce an output, or can be otherwise actuated by instructions from the system, such as instructions generated by the camera 110 responsive to identifying one or more actions.

The output devices may include any components of the environment 100. For example, the output devices may include the door 132, the e-lock 133, light sources (e.g., the exterior light 138, or the interior light 137, among others) the window 136, the speakers 116, the garage door 162, or other such output devices like a sprinkler system, pathway or garden lights, appliances of the building 130 (e.g., a coffee maker, oven, refrigerator, dehumidifier, etc.), a display of the building 130 (e.g., a projector or television), among others. The output devices may be a part of or included in a subsystem of the environment 100. A subsystem of the environment 100 can include a subsystem of the building 130, such as can include a heating ventilation air-conditioning (HVAC) system designed to regulate temperature, air flow, humidity, or the climate of the building 130 and the surrounding environment 100. A subsystem of the environment 100 can include a plumbing system designed to regulate water flow throughout the environment 100, such as to toilets, showers, bathtubs, sinks, hoses, or a sprinkler. A subsystem of the environment 100 can include a lighting system designed to control lights, light fixtures, or light sources of the environment 100, such as a porch light, spotlight, strobe light, the interior light 137, the exterior light 138, pathway lights, among others.

The output devices may perform the one or more identified actions according to the instructions generated for performing the actions. The system may generate the instructions according to the identified actions. For example, the system may generate the instructions to include a period of time to perform the action, an intensity (e.g., volume for an audio output, brightness for a light output, etc.) with which to perform the action, a frequency with which to perform the action, among others. For example, the action may include playing a noise from the speaker 116. The system can play the noise or any sounds at any volume, tone, or pitch. The system can play the noise for any duration. In some cases, the system can cause the output devices to perform an action until detecting a stimulus, such as a change in a characteristic of the entity or the detection of a second entity. For example, the system can light a porch light until detecting that the entity has entered the building 130 via the door 132. For example, the system can illuminate lights of a walkway as the entity approaches a front door, such as the door 132, and turn off walkway lights which are a threshold distance behind the entity.

The system may actuate the output devices according to the preferences of the profile. In some cases, the preferences of the profile can indicate one or more output devices to actuate based on the preferences, the criteria of the entity, or the state of the area, among others. For example, the preferences of the entity may indicate that the entity enjoys coffee between 6 AM and 10 AM. As an illustrative example, upon the entity approaching the building at 8 AM (perhaps post a run, or upon retrieving the mail, etc.) the system may actuate a coffee maker within the building to being brewing coffee. The system may determine to perform the action from the preferences, or the preferences may indicate the action. For example, the system may determine to brew coffee based on the preferences of the profile indicating that the entity enjoys coffee between 6 AM-10 AM and that the state of the environment 100 indicates that it is currently within that time range. For example, the system may determine to brew coffee based on a preference stating for the system to brew coffee if it is between 6 AM-10 AM and the entity is detected approaching the building 130 or moving within the building 130.

In some cases, the system may actuate a series of actions based on the preferences indicated in the profile for the entity. Actions taken by the system in accordance with the preferences of the entity may be performed sequentially, in parallel, singularly, in multitudes, or in a combination thereof. For example, upon a detection that the entity is approaching the building 130 and an identification of the profile associated with the entity, the system may illuminate lights of a path to guide the entity to the door, may unlock the door, and may initiate coffee brewing. In this manner, the system can actuate a sequence of the actions according to the preferences established for the entity.

Each output device may perform one or more actions. For example, the exterior light 138 may perform a first action corresponding to an unfriendly entity. The first action may be to flash, strobe, or spotlight the unfriendly entity using the light 138. In this illustrative example, the exterior light 138 may also perform a second (or further) action corresponding to a friendly entity. The second action may include the exterior light 138 lighting at an intensity to welcome the entity and illuminate the door 132 or a porch.

In some cases, a second entity may approach or enter the area subsequent to or concurrently with a first entity. The first entity may be identified as friendly and the second entity may be identified as unfriendly. The system may initially determine actions corresponding to a friendly entity and may perform the actions corresponding to the friendly entity. For example, the system may determine to perform actions to welcome the friendly entity, such as stating a greeting via the speaker 16 or actuating a coffee machine to make a cup of coffee within the building 130. Upon detection of the second entity, the system may determine a second set of actions to perform based on the identified criteria of the second entity. In some cases, the second set of actions can contradict the actions to welcome the friendly entity. For example, the actions to welcome the friendly entity can include lighting up the porch light. Upon a detection of an unfriendly second entity, the system may determine to strobe the porch light to deter the second unfriendly entity. In this manner, a detection of an unfriendly entity and deterrence of such an entity is not compromised by performance of friendly actions for a friendly entity.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
an image capture device;
output devices; and
one or more processors coupled with memory and configured to:
detect, using the image capture device, an entity approaching an area;
determine, based on attributes of the entity detected by the image capture device, that the entity corresponds to a profile;
identify one or more actions corresponding to preferences indicated in the profile; and
actuate one or more of the output devices to perform the one or more actions to receive the entity to the area.

2. The system of claim 1, wherein to detect the entity approaching the area, the one or more processors are configured to receive, from a client device associated with the entity, an indication that the entity has entered a perimeter of a geographic area.

3. The system of claim 2, wherein the indication includes an identification of the profile.

4. The system of claim 1, wherein to detect the entity approaching the area, the one or more processors are configured to detect, using the image capture device, at least one of physical characteristics of the entity or behavioral characteristics of the entity.

5. The system of claim 1, wherein the one or more processors are configured to:
detect the entity approaching the area based on images captured of the entity;
determine, using image recognition techniques, features of the entity from the images; and
determine that the entity corresponds to the profile responsive to determining that the features of the entity meet a threshold.

6. The system of claim 1, wherein the one or more processors are configured to:
generate a second profile corresponding to a second entity.

7. The system of claim 1, wherein the output devices comprise one or more of:
a light source;
a speaker;
a display device;
an appliance;
a climate control system;
a lock;
an entrance; or
a water system.

8. The system of claim 1, wherein to identify the one or more actions, the one or more processors are configured to provide the attributes of the entity and the preferences as inputs to a machine learning model.

9. The system of claim 1, wherein the one or more processors are further configured to:
detect, using the image capture device, a second entity approaching the area;
determine that the second entity does not correspond to one of a plurality of profiles comprising the profile;
identify one or more second actions based on the second entity to deter the entity from perpetrating an act; and
actuate one or more of the output devices to perform the one or more second actions.

10. The system of claim 1, wherein the actions comprise turning on a light system to guide the entity within the area.

11. The system of claim 1, wherein the one or more processors are further configured to determine the one or more preferences indicated in the profile based on historic actions of the entity within the area.

12. The system of claim 1, wherein the preferences are established via a client device, and wherein to actuate one or more of the output devices to perform the one or more actions to receive the entity, the one or more processors are configured to actuate a sequence of the actions according to the preferences established via the client device.

13. A method comprising:
detecting, using one or more processors coupled with memory and an image capture device, an entity approaching an area;
determining, using the one or more processors, based on attributes of the entity detected by the image capture device, that the entity corresponds to a profile;
identifying, using the one or more processors, one or more actions corresponding to preferences indicated in the profile; and
actuating, using the one or more processors coupled with output devices, one or more of the output devices to perform the one or more actions to receive the entity to the area.

14. The method of claim 13, wherein detecting the entity approaching the area comprises receiving, from a client device associated with the entity, an indication that the entity has entered a perimeter of a geographic area.

15. The method of claim 13, comprising:
detecting, using the one or more processors, the entity approaching the area based on images captured of the entity;
determining, using the one or more processors operating image recognition techniques, features of the entity from the images; and
determining, using the one or more processors, that the entity corresponds to the profile responsive to determining that the features of the entity meet a threshold.

16. The method of claim 13, wherein the output devices comprise one or more of:
a light source;
a speaker;
a display device;
an appliance;
a climate control system;
a lock;
an entrance; or
a water system.

17. The method of claim 13, wherein identifying the one or more actions comprises providing, using the one or more processors, the attributes of the entity and the preferences as inputs to a machine learning model.

18. The method of claim 13, comprising:
detecting, using the one or more processors and the image capture device, a second entity approaching the area;
determining, using the one or more processors, that the second entity does not correspond to one of a plurality of profiles comprising the profile;
identifying, using the one or more processors, one or more second actions based on the second entity to deter the entity from perpetrating an act; and
actuating, using the one or more processors, one or more of the output devices to perform the one or more second actions.

19. The method of claim 13, comprising determining, using the one or more processors, the one or more preferences indicated in the profile based on historic actions of the entity within the area.

20. The method of claim 13,
wherein the preferences are established via a client device; and
wherein actuating the one or more of the output devices to perform the one or more actions to receive the entity comprises actuating, by the one or more processors, a sequence of the actions according to the preferences established via the client device.
